(19) United States
(12) Patent Application Publication
(10) Pub. No.: US 2025/0109753 A1
(43) Pub. Date: Apr. 3, 2025

(54) USER POSITION-BASED FAN NOISE CONTROL

(71) Applicant: Microsoft Technology Licensing, LLC, Redmond, WA (US)

(72) Inventors: Adwaita Anil DANI, Redmond, WA (US); Manish Keshrichand SHAH, Redmond, WA (US)

(21) Appl. No.: 18/478,530

(22) Filed: Sep. 29, 2023

(51) Int. Cl. F04D 29/66; F04D 27/00; G06F 1/20; G06T 7/70

(52) U.S. Cl. CPC F04D 29/661; F04D 27/004; G06F 1/20; G06T 7/70; G06T 2207/30196

(57) ABSTRACT

Systems and methods are disclosed where a user's position with respect to an electronic device including a fan is detected. A noise of the fan perceived by a user based on the user's position with respect to the electronic device is detected. A determination whether increased thermal dissipation is required is made and whether the noise of the fan perceived by the user is below a noise threshold. The system may increase fan speed if both increased thermal dissipation is required and if the noise of the fan is below the noise threshold.

### CROSS-REFERENCE TO RELATED APPLICATIONS

N/A

### BACKGROUND

Electronic devices include one or more heat-producing components, such as processors, that typically produce heat in the order of 15-45 W. These electronic devices often include a fan that dissipates the heat generated inside of the electronic device in order to keep the system from overheating. The faster the fan's speed is, the more heat it can dissipate. The speed at which fan rotates (revolutions per minute, or rpm) is directly related to a fan noise a user may hear. The higher the fan speed is, the more noise it produces. Running a fan inside an electronic device with high speed (e.g., high rpm) may cause significant amount of noise that many users of an electronic device may find disconcerting. For this reason, many electronic device manufacturers limit the maximum speed a fan can rotate.

### BRIEF SUMMARY

In some embodiments, a method for controlling fan noise in an electronic device is provided. The method includes detecting a user's position with respect to the electronic device including a fan. The method further includes determining a fan noise perceived by a user based on the user's position with respect to the electronic device. The method further includes determining whether increased thermal dissipation is required. The method further includes determining whether the fan noise perceived by the user is below a noise threshold. The method further includes increasing a fan speed if both increased thermal dissipation is required and if the fan noise perceived by the user is below the noise threshold.

In other embodiments, a method for controlling fan noise in an electronic device is provided. The method includes detecting a position of a user with respect to the electronic device including a fan. The method further includes detecting a fan noise perceived by the user based on the position of the user with respect to the electronic device, and decreasing a fan speed, if the position of the user with respect to the electronic device is less than a distance at a nominal position.

In yet other embodiments, an electronic device for controlling fan noise is provided. The electronic device includes a fan, a position detections system and means for controlling a fan speed when both the position detection system indicates that a user is further from the electronic device than a distance at a nominal position and that an increase in thermal dissipation is required.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates a system for controlling fan noise in an electronic device, in accordance with at least one or more embodiments.

FIG. 2 illustrates a system for controlling fan noise in an electronic device, in accordance with at least one or more embodiments.

FIG. 3 illustrates a device for controlling fan noise, in accordance with at least one or more embodiments.

FIG. 4 illustrates a system for setting a noise threshold for an electronic device including a fan, in accordance with at least one or more embodiments.

FIG. 5 illustrates a system for controlling fan noise in an electronic device, in accordance with at least one or more embodiments.

FIG. 6 illustrates a system for controlling fan noise in an electronic device, in accordance with at least one or more embodiments.

FIG. 7A illustrate a detection system of an electronic device, in accordance with at least one or more embodiments.

FIG. 7B illustrate a detection system of an electronic device, in accordance with at least one or more embodiments.

FIGS. 8A and 8B illustrates an example tables of perceived noise of a fan based on a distance, in accordance with at least one or more embodiments.

FIGS. 9-1, and 9-2 illustrate stages of an example user interface for changing a noise threshold, in accordance with at least one or more embodiments.

FIG. 10 illustrates a series of acts for controlling fan noise in an electronic device, in accordance with at least one or more embodiments.

FIG. 11 illustrates a series of acts for controlling fan noise in an electronic device, in accordance with at least one or more embodiments.

FIG. 12 illustrates certain components that may be included within a computer system, in accordance with one or more embodiments.

### DETAILED DESCRIPTION

This disclosure generally relates to a user position-based fan noise control.

Typically, manufacturers set a maximum fan speed for an electronic device, such as a laptop, tablet, gaming device, computer, etc., as many users find fan noise irritating when using the electronic device. Noise levels are measured in decibels (dB), but dB sound pressure levels are unweighted for a human ear. Decibels can be adjusted to human hearing. Noise levels measured in “A-weighted” decibel (dBA) levels to approximate the way a user hears it. According to some estimates an acceptable fan noise is typically between 30 dBA and 36 dBA, although some individuals may prefer (or require) even lower than 30 dBA.

In some situations, it would be advantageous if the fan speed could be increased due to a change in circumstances. For example, in some situations, there may be a need to increase the performance of the electronic device by providing more power to the processor. By providing more power to the processor, more heat is generated, and thus, a higher fan speed may be required. In some situations, there might be a need to decrease the fan speed. For example, if the user has increased sensitivity for noise (e.g., due to hyperacusis), or the user is hearing an increased noise level from the fan due to their unusually close position to the device.

Furthermore, due to acoustic behavior of an electronic device, the perceived fan noise measured at same distance away from the electronic device may not have the same perceived fan noise levels if the angle and/or the position between the fan and the user is not the same. This is especially applicable in situations where the electronic device may be oriented different ways which can impact the fan noise perceived by a user. For example, if the electronic device has a display that may be rotated, or if the electronic device does not have a display and user may orient it any way they like.

In some situations, an electronic device may include more than one fan, allowing the system to increase one fan's speed, but not the other. For example, based on the user's position, the fan furthest away from the user may be run faster than the fan closest to the user.

The features and functionalities described herein provide a number of advantages and benefits over conventional approaches and systems. For example, the systems described herein provide features and functionalities relating to efficient cooling of electronic devices. Indeed, the systems described herein provide a system for controlling fan noise in an electronic device based on the user's position with respect to the electronic device. For example, if a user is further away from the electronic device than a preset distance at a nominal position, the fan noise may be increased. In another example, if a user is closer to the electronic device than a preset distance at a nominal position, the fan noise may be decreased. One possible advantage of allowing to control fan noise based on detected user's position including the angle between the electronic device and the user is that the perceived fan noise at two different positions may not be the same even if the two positions are same distance away from the electronic device.

In addition to controlling fan noise in an electronic device based on the user's position, one or more embodiments of the systems and methods described herein provide a system for the user to customize a preset threshold for a fan noise perceived by the user. For example, the user is able to adjust the preset threshold for fan noise by either increasing or decreasing the preset threshold. By allowing a user to customize the fan noise settings, a user may enjoy the electronic device usage more than before.

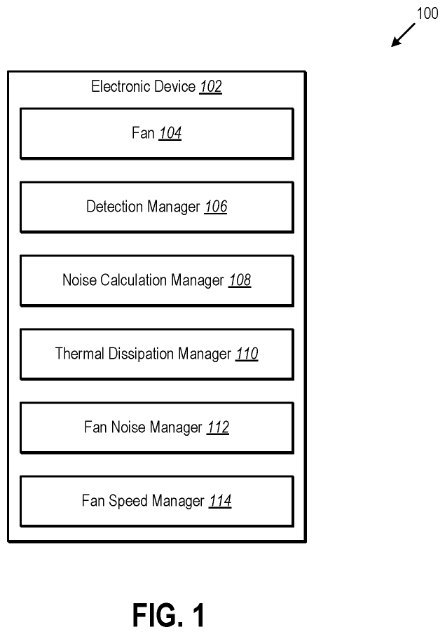

FIG. 1 illustrates a system 100 for controlling fan noise in an electronic device, in accordance with at least one or more embodiments. In one or more embodiments, the system 100 includes an electronic device 102. For example, the electronic device 102 may be a laptop, a tablet, a computing device, a mobile phone, a gaming device, a computer, or combinations thereof. As shown in FIG. 1 the electronic device 102 may include a fan 104. In one or more embodiments, the fan 104 is configured to draw cooler air inside of a chassis from the outside and dissipate heat from inside of the chassis to the outside. In one or more embodiments, the fan 104 is a centrifugal fan. In one or more embodiments, the fan 104 is an axial fan. In one or more embodiments, the fan 104 has a maximum speed (e.g., a rotational speed, such as rpm). For example, the fan 104 may have a maximum speed of 5000 rounds-per-minute (rpm). In another example, the fan 104 may have a maximum speed of 3000 rpm.

In one or more embodiments, the electronic device 102 includes a detection manager 106. In one or more embodiments, the detection manager 106 is configured to detect a user's position with respect to the electronic device 102. For example, the position may be detected as a distance. In another example, the position may be detected in three-dimension including the angle between the user and the electronic device 102. In one or more embodiments, the detection manager 106 includes a sensor. In one or more embodiments, the sensor is a Time-of-Flight (ToF) sensor. For example, the electronic device 102 may include an illumination component for illuminating a scene with one or more light pulses, and an image sensor to detect reflected light pulses from the scene. For example, the light may be infrared. In one or more embodiments, the sensor is a Light Detection and Ranging (LiDAR) sensor. For example, the electronic device 102 may include a laser illumination component for illuminating a scene with a laser and an image sensor to detect reflected light from the scene. A distance may be measured based on the time it takes for the light pulse to be reflected from the user and back to the image sensor. For example, the laser light may be ultraviolet, visible, or near-infrared light. In one or more embodiments, the sensor is a Millimeter-Wave Radar. For example, the electronic device 102 may include a transmitter and a receiver for transmitting and receiving electromagnetic waves. In one or more embodiments, the sensor is one or more of a RGB camera, an RGB-D camera, or a combination thereof. For example, the electronic device 102 may include one or more cameras and a three-dimensional (3D) imaging algorithm configured to produce a 3D image from the one or more images captured by the one or more cameras.

In one or more embodiments, the detection manager 106 initiates the detection procedure when the fan 104 starts to rotate. In one or more embodiments, the detection manager 106 is configured to detect the user's position at set intervals while the fan 104 is rotating. For example, the detection manager 106 may be configured to detect the user's position every two or three minutes. In another example, the detection manager 106 may be configured to detect the user's position every ten to twenty minutes. In yet another example, the detection manager 106 may be configured to detect the user's position in intervals that are less than two minutes. In yet another example, the detection manager 106 may be configured to detect the user's position in intervals that are over twenty minutes long.

As shown in FIG. 1, the electronic device 102 may further include a noise calculation manager 108. In one of more embodiments, the noise calculation manager 108 is configured to calculate the noise of the fan 104 perceived by a user based on the user's position with respect to the electronic device. In one or more embodiments, the noise calculation manager 108 includes a table of noise levels vs. distance. For example, the noise calculation manager 108 may compare the measured distance to the stored table and get the noise of the fan 104 associated with the measured distance. In one or more embodiments, the noise calculation manager 108 includes an algorithm that provides the mathematical equation for calculating the noise of the fan 104 based on the measured distance. In one or more embodiments, the noise calculation manager 108 includes a trained machine learning model that takes user position information and fan speed as inputs and outputs an estimate of the noise perceived. For example, the user position information may include one or more of a distance with respect to the electronic device, the angle between the user and the electronic device, and the angle between a first chassis and the second chassis of the electronic device.

In one or more embodiments, the electronic device 102 further includes a thermal dissipation manager 110. In one or more embodiments, the thermal dissipation manager 110 is configured to determine whether increased thermal dissipation is required. For example, the thermal dissipation manager 110 may be able to detect an increase of heat inside the electronic device 102. In one or more embodiments, the thermal dissipation manager 110 is able to detect a requirement to increase performance of a processor. For example, the thermal dissipation manager 110 may detect that a power mode of the electronic device 102 has been changed to a higher performance level. In one or more embodiments, the user may manually select a power mode (e.g., a low-performance level, a medium-performance level, and a high-performance level). In one or more embodiments, the electronic device 102 may automatically select a higher power mode based on detected usage of the electronic device 102 or based on requirements of a software running on the electronic device 102. In one or more embodiments, the thermal dissipation manager 110 can increase the thermal dissipation in case a touch temperature of the electronic device 102 increases above touch temperature limits. For example, if there is increase in heat generated inside the chassis and/or due to higher ambient temperatures.

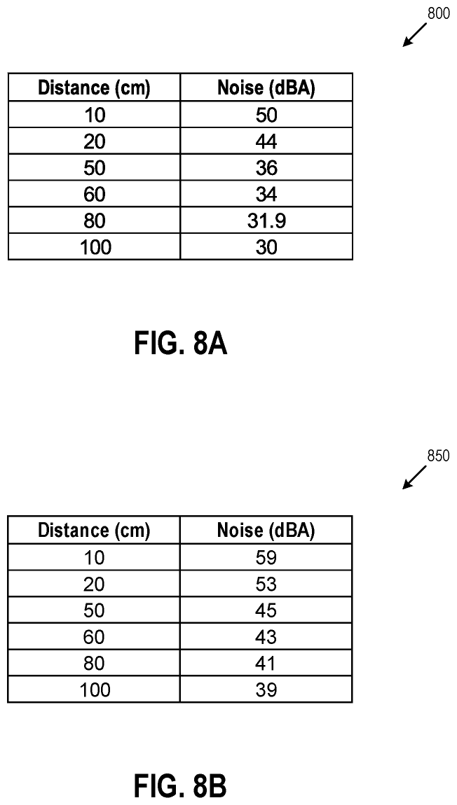

As shown in FIG. 1, the electronic device 102 may further include a fan noise manager 112. In one or more embodiments, the fan noise manager 112 is configured to determine whether the noise of the fan 104 is below a noise threshold. In one or more embodiments, the fan noise manager 112 determines whether or not the noise of the fan 104 is below the noise threshold based at least on one or more of the user's position with respect to the electronic device 102, and the fan speed, as further discussed in connection to FIGS. 8A and 8B.

In one or more embodiments, the noise threshold is based on a maximum allowed speed of the fan 104. In one or more embodiments, the noise threshold is set by a manufacturer. For example, the manufacturer may set a maximum noise threshold based on expected position of a user (i.e., a nominal position). In one or more embodiments, the noise threshold is set by a user. For example, the user may manually increase or decrease a noise threshold set by a manufacturer. In one or more embodiments, the noise threshold is set between 25 dBA and 40 dBA. In one or more embodiments, the noise threshold is set below 25 dBA. In one or more embodiments, the noise threshold is set above 40 dBA. It should be noted that even if the examples here measure the noise in dBA, in one or more embodiments, the threshold could be set using a dB measurement system, or by using any other measurement system for measuring sound intensity.

As shown in FIG. 1, the electronic device 102 may further include a fan speed manager 114. In one or more embodiments, the fan speed manager 114 is configured to increase the fan speed if both increased thermal dissipation is required and if the noise of the fan 104 is below the noise threshold. In one or more embodiments, the fan speed manager 114 is configured to increase the fan speed to a new speed based on the detected user's position. For example, if the detected user's position is further away than the nominal position, the perceived noise of the fan 104 will be less than if the user is at the nominal position.

In one or more embodiments, the nominal position is set by the manufacturer of the electronic device 102, similarly, as the threshold noise. For example, the nominal position may be a user's two-dimensional distance with respect to the electronic device 102. In some embodiments, the nominal position may be three-dimensional distance including an angle between the electronic device 102 and the user. For example, if the detected user's position is at the same distance away as the nominal position, but the angle between the fan and the user's position has changed from the nominal position, the perceived fan noise may be either lower or higher than the threshold noise due to the acoustic behavior of the electronic device 102.

In one or more embodiments, the electronic device 102 may include two or more fans 104 and the fan speed manager 114 may increase or decrease each fan's speed individually. This may be especially advantageous in situations where one fan is located closer to the user than another fan, allowing the fan speed manager 114 to operate the fan that is further away from the user with higher speed than the fan that is located closer to the user.

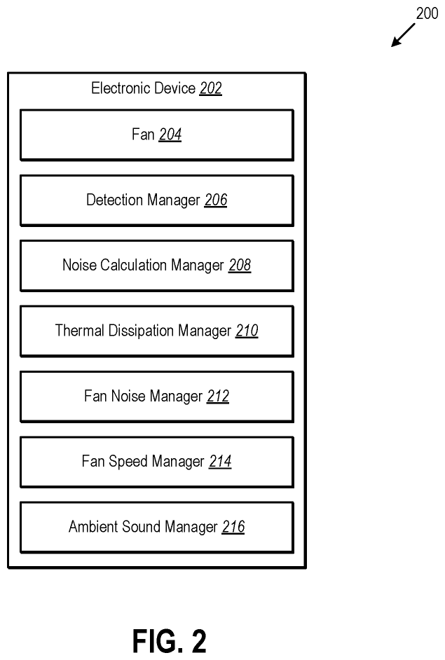

FIG. 2 illustrates a system 200 for controlling fan noise in an electronic device, in accordance with at least one or more embodiments. In one or more embodiments, the system 200 includes an electronic device 202, such as the electronic device discussed in connection with FIG. 1. Similarly, as the system 100 in FIG. 1, the system 200 in FIG. 2 includes a fan 204 (such as the fan 104), a detection manager 206 (such as the detection manager 106), a noise calculation manager 208 (such as the noise calculation manager 108), a thermal dissipation manager 210 (such as the thermal dissipation manager 110), a fan noise manager 212 (such as the fan noise manager 112) and a fan speed manager 214 (such as the fan speed manager 114). The electronic device 202 may further include an ambient sound manager 216. In one or more embodiments, the ambient sound manager 216 is configured to measure the ambient sound level surrounding the electronic device 202. In one or more embodiments, if the measured ambient sound level is higher than the noise threshold, the fan speed manager 214 may increase the fan speed. In one or more embodiments, the ambient sound manager 216 may perceive the ambient sound level through one or more microphones located in the electronic device 202.

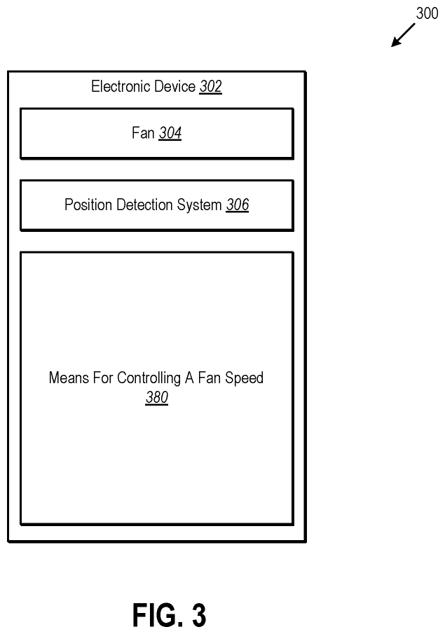

FIG. 3 illustrates a device 302 for controlling fan noise, in accordance with at least one or more embodiments. The electronic device includes a fan 304, a position detection system 306, and means for controlling a fan speed when the position detection system indicates that a user is further from the electronic device than a distance at a nominal position and that an increase in thermal dissipation is required 380. In one or more embodiments, the fan 304 may be the fan 104 of FIG. 1, or the fan 204 of FIG. 2. In one or more embodiments, the position detection system 306 includes a sensor. For example, the sensor may be a Time-of-Flight (ToF) sensor, a Light Detection and Ranging (LiDAR) sensor, or a Millimeter-Wave Radar sensor. In one or more embodiments, the sensor is one or more of a RGB camera, an RGB-D camera, or a combination thereof. In one or more embodiments, the means for controlling a fan speed includes one or more of a noise calculation system, a thermal dissipation system, a fan noise system, a fan speed system, and an ambient sound system. For example, the noise calculation system may include a noise calculation manager, such as the noise calculation manager 108 or 208 as described above. For example, the thermal dissipation system may include a thermal dissipation manager, such as the thermal dissipation manager 110 or 210 as described above. For example, the fan noise system may include a fan noise manager, such as the fan noise manager 112 or 212 as described above. For example, the fan speed system may include a fan speed manager, such as the fan speed manager 114 or 214 as described above. For example, the ambient sound system may include an ambient sound manager, such as the ambient sound manager 216 of FIG. 2.

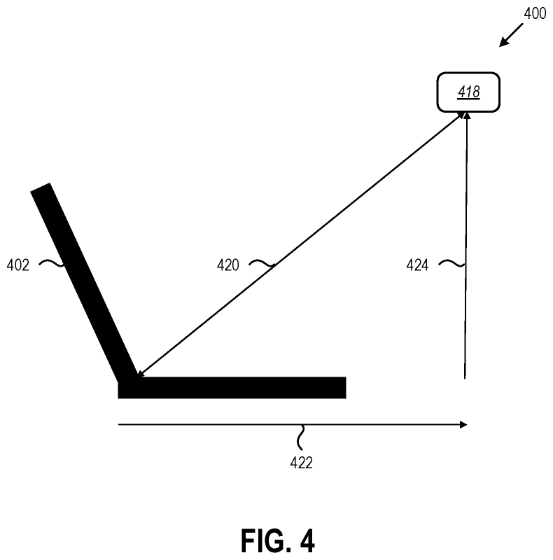

FIG. 4 illustrates a system 400 for setting a noise threshold for an electronic device 402 including a fan (not shown), in accordance with at least one or more embodiments. In one or more embodiments, the electronic device 402 is the electronic device 102 as previously discussed in connection with FIG. 1, or the electronic device 202 as previously discussed in connection with FIG. 2. In one or more embodiments, a microphone 418 is placed at a nominal position 420. For example, the nominal position 420 may be the sum of an x-vector 422 and a y-vector 424. In another example, the nominal position 420 may be a three-dimensional distance including an angle between the electronic device 402 and the user. In one or more embodiments, the nominal position 420 is selected based on a most likely position a user of the electronic device 402 would have their ears when using the electronic device 402. For example, if the electronic device has a small display size, the nominal position 420 may be much shorter than if the electronic device has a larger display size. In one or more embodiments, the fan (not shown) of the electronic device 402 is run at different speeds while the microphone 418 records the noise of the fan. Once the system 400 has determined the noise of the fan at the nominal position 420 with various different speeds of the fan, the speed of the fan may be limited based on a noise threshold. For example, if it is required that the noise of the fan does not exceed 35 dBA, and fan speed of 4000 rpm has a 35 dBA noise at nominal position 420 with respect to the electronic device 402, then the fan speed may be limited to 4000 rpms by the system 400, even if the fan may have a higher maximum speed it can rotate. In one or more embodiments, the maximum set noise threshold can be changed, as will be further discussed in connection with FIGS. 9-1, 9-2, and 9-3.

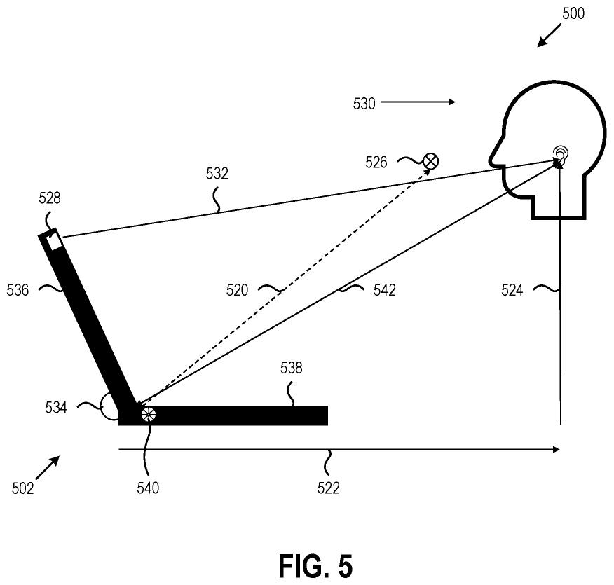

FIG. 5 illustrates a system 500 for controlling fan noise in an electronic device 502, in accordance with at least one or more embodiments. In one or more embodiments, the electronic device 502 has a preset noise threshold set for a nominal position 520. For example, the nominal position 520 may have been set by using the techniques discussed above. The nominal position 520 represents the position at which a user 530 of the electronic device 502 will most likely be positioned when using the electronic device 502.

In one or more embodiments, the electronic device 502 includes a position detection system 528. The position detection system 528 may be a sensor. In one or more embodiments, the sensor is a Time-of-Flight (ToF) sensor. For example, the electronic device 502 may include an illumination component for illuminating a scene with one or more light pulses, and an image sensor to detect reflected light pulses from the scene. For example, the light may be infrared. In one or more embodiments, the sensor is a Light Detection and Ranging (LiDAR) sensor. For example, the electronic device 502 may include a laser illumination component for illuminating a scene with a laser and an image sensor to detect reflected light from the scene. For example, the laser light may be ultraviolet, visible, or near-infrared light. In one or more embodiments, the sensor is a Millimeter-Wave Radar. For example, the electronic device 502 may include a transmitter and a receiver for transmitting and receiving electromagnetic waves. In one or more embodiments, the sensor is one or more of a RGB camera, an RGB-D camera, or a combination thereof. For example, the electronic device 502 may include one or more cameras and a three-dimensional (3D) imaging algorithm configured to produce a 3D image from the one or more images captured by the one or more cameras.

In one or more embodiments, the position detection system 528 detects a user's position 542 with respect to the electronic device 502 including a fan 540. The detected position 542 is the sum of an x-vector 522 and a y-vector 524, wherein the x-vector 522 and the y-vector are measured from the fan location. In one or more embodiments, the position detection system 528 is able to compare the detected position 542 to the nominal position 520. As shown in FIG. 5, the detected position 542 is further away from the electronic device 502 than the nominal position 520.

The electronic device 502 is further configured to control the fan speed when both the position detection system 528 indicates that the user 530 is further away from the electronic device 502 than the nominal position 520 and an increase in thermal dissipation is required. For example, the electronic device 502 may increase the fan speed in case the user 530 is further away from the electronic device 502 than the nominal position 520 and an increase in thermal dissipation is required.

In one or more embodiments, the electronic device 502 may be the electronic device 102 of FIG. 1, or the electronic device 202 of FIG. 2. For example, the electronic device 502 may include a thermal dissipation manager, such as the thermal dissipation manager 110 of FIG. 1, that is configured to determine whether increased thermal dissipation is required. For example, the electronic device 502 may be able to detect an increase of heat inside the electronic device 502. In one or more embodiments, the electronic device 502 is able to detect a requirement to increase performance of a processor. For example, the electronic device 502 may detect that a power mode of the electronic device 502 has been changed to a higher performance level. In one or more embodiments, the user may manually select a power mode (e.g., a low-performance level, a medium-performance level, and a high-performance level). In one or more embodiments, the electronic device 502 may automatically select a higher power mode based on detected usage of the electronic device 502 or based on requirements of a software running on the electronic device 502. In one or more embodiments, the thermal dissipation manager can increase the thermal dissipation in case a touch temperature of the electronic device 502 increases above touch temperature limits. For example, if there is increase in heat generated inside the chassis and/or due to higher ambient temperatures.

In one or more embodiments, the electronic device 502 is configured to initiate a user detection with the position detection system 528 when the fan 540 starts to rotate. In one or more embodiments, the position detection system 528 is configured to detect the user's position 532 at set intervals while the fan 540 is rotating. For example, the position detection system 528 may be configured to detect the user's position every two or three minutes. In another example, the position detection system 528 may be configured to detect the user's position every ten to twenty minutes. In yet another example, the position detection system 528 may be configured to detect the user's position in intervals that are less than two minutes. In yet another example, the position detection system 528 may be configured to detect the user's position in intervals that are over twenty minutes long.

As shown in FIG. 5, the electronic device 502 is a two-part electronic device including a first chassis 536 and a second chassis 538. In one or more embodiments, the angle 534 is used for calculating the position 532 to the user 530. For example, when the angle 534 is less than 90 degrees, the position detection system 528 is further away from the user 530 than when the angle 534 is 90 degrees. In the example shown in FIG. 5, the fan 540 is located in the second chassis 538. Hence, even if the position detection system 528 is further away from the user 530, the fan's position to the user has not changed and thus the noise of the fan has not changed. In one or more embodiments, the position detection system 528, when calculating the fan noise perceived by the user 530, takes into consideration the angle 534 between the first chassis 536 and the second chassis 538. For example, the electronic device 502 may include an accelerometer, an angular position sensor (e.g., an angle position detector, gyroscope), or any other type of sensor to detect the angle between the first chassis 536 and the second chassis 538. One possible advantage of taking into consideration the angle 534 is that the electronic device 502 may be able to calculate the actual position 542 between the fan 540 and the user 530, instead of the position between the position detection system 528 and the user 530. By calculating the actual position 542, the system might be capable of providing more accurate fan noise calculations than when the detected position 532 is used. It should be noted that even if the electronic device 502 in FIG. 5 is a multi-part electronic device (e.g., a laptop), the electronic device may, in one or more embodiments, be a single body electronic device (e.g., tablet, desktop).

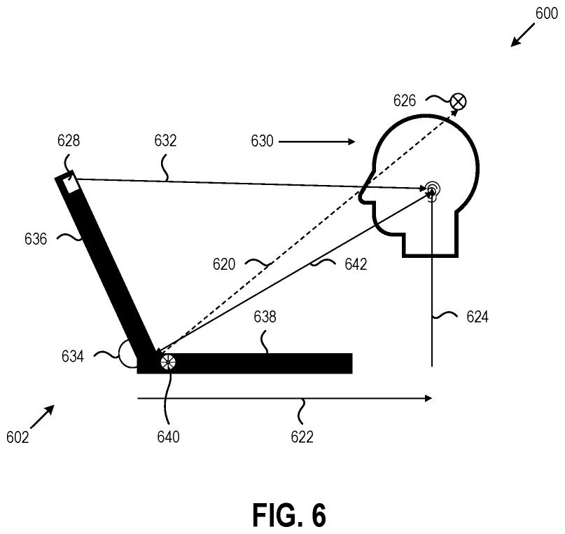

FIG. 6 illustrates a system 600 for controlling fan noise in an electronic device 602, in accordance with at least one or more embodiments. In one or more embodiments, the electronic device 602 has a preset noise threshold set for a nominal position 620. For example, the nominal position 620 may have been set by using the techniques discussed above. The nominal position 620 represents the most likely position 626 at which a user 630 of the electronic device 602 will be when using the electronic device 602.

In one or more embodiments, the electronic device 602 includes a position detection system 628. The position detection system 628 may be similar to the position detection system 528 described in connection with FIG. 5. Furthermore, the electronic device 602 may be similar to the electronic device 102 of FIG. 1, or the electronic device 202 of FIG. 2. In one or more embodiments, the electronic device 602 is capable of detecting a user's position with respect to the electronic device with the position detection system 628. The position may be a detected position 632 between the position detection system 628 and the user 630, or an actual position 642 between a fan 640 and the user 630. The electronic device 602 is further able to calculate a noise of the fan perceived by the user based on the user's position 632, 642. The electronic device 602 is configured to decrease a fan speed if the user's position with respect to the electronic device is less than the position at a nominal position. As shown in FIG. 6, the user 630 is closer to the electronic device 602 than the nominal position 620, therefore the electronic device 602 decreases the fan speed.

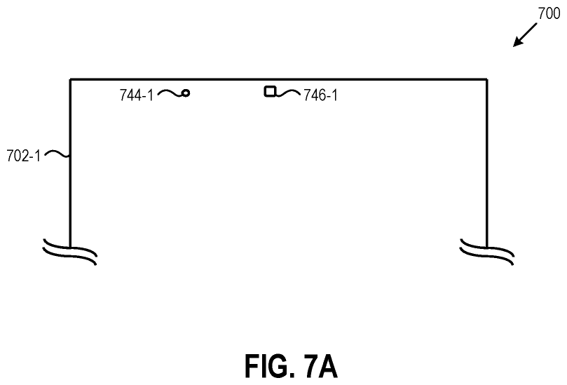

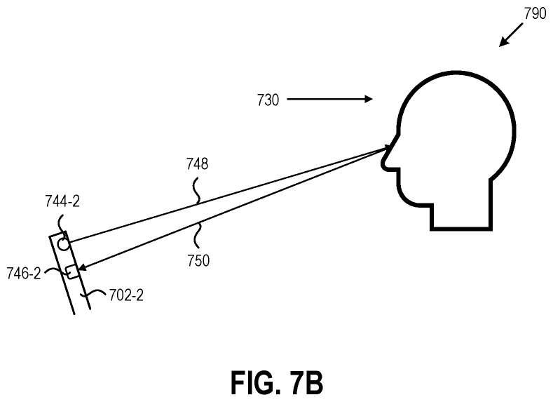

FIGS. 7A and 7B illustrate a detection system 700, and a detection system 790 of an electronic device, in accordance with at least one or more embodiments. As shown in FIG. 7A, an electronic device 702-1 includes a transmitter 744-1 and a receiver 746-1. In one or more embodiments, the transmitter 744-1 is an illumination component illuminating a scene with one or more light pulses, and the receiver 746-1 is an image sensor that detects reflected light pulses from the scene. For example, the transmitter 744-1 may transmit infrared light. In another example, the transmitter 744-1 may transmit ultraviolet, visible, or near-infrared light. In yet another example, the transmitter 744-1 may transmit electromagnetic waves. In one or more embodiments, the receiver 746-1 is a sensor capable of receiving one of the transmitted lights, or the electromagnetic waves, that reflect back from a user.

Typically, an electronic device may include one or more RGB cameras at the top bezel area of a display. For privacy reasons, in many systems, a red light will notify the user that their camera is actively recording them. One possible advantage of using a separate sensor (instead of the RGB camera sensor) for detecting the user's position for controlling a fan noise is that the user's privacy will not be violated.

As shown in FIG. 7B, the detection system 790 includes an electronic device 702-2 that includes a transmitter 744-2 and a receiver 746-2. The transmitter 744-2 may be the transmitter 744-1 described in connection to FIG. 7A and the receiver 746-2 may be the receiver 746-1 described in connection to FIG. 7A. In the embodiment shown in FIG. 7B, the transmitter 744-2 and the receiver 746-2 may be placed on top of each other. The transmitter 744-2 may transmit 748 various wavelengths of light or electromagnetic waves and the receiver 746-2 may receive 750 the reflected light waves or the electromagnetic waves back from the user 730.

FIGS. 8A and 8B illustrate an example table 800 and table 850 of perceived noise of a fan based on a distance, in accordance with at least one or more embodiments. As shown in FIG. 8A, when the distance is 10 cm, the perceived noise of a fan is 50 dBA, and as the distance grows, the perceived noise of the fan lowers. Similarly, in FIG. 8B, at distance 10 cm the perceived noise of the fan is 59 dBA. For example, a fan may be rotating at 5900 rpm in FIG. 8A, and the fan may be rotating at 6900 rpm in FIG. 8B. In one or more embodiments, a manufacturer may have determined that an average position (i.e., the nominal position) of the user with respect to the electronic device is 50 cm and has set a fan speed threshold to 5900 rpms based on the nominal position and a threshold noise level (e.g., not to exceed 36 dBA). If the detected distance, when the electronic device is been used, is 60 cm instead of the expected distance at the nominal position, 50 cm, the system may increase the speed of the fan to 6100 rpm because at 60 cm away with 6100 rpm the perceived noise is 36 dBA, which meets the set threshold noise level of 36 dBA.

In one or more embodiments, the electronic device may store in memory tables, such as the tables shown in FIGS. 8A and 8B, that provide information about the perceived noise of a fan based on a position with various different fan speeds. For example, the system may compare the actual detected user position with the known fan speed to a noise threshold and may select a new fan speed by either increasing or decreasing the current fan speed.

In one or more embodiments, the electronic device may store in memory a mathematical equation for calculating the perceived noise of a fan based on a detected position. For example, the mathematical equation may be:

$$S P {L}_{B} = S P {L}_{A} - 20 {log}_{10} \frac{{R}_{B}}{{R}_{A}}$$

wherein SPL_{A/B} is the sound pressure level in dBA at position A/B, and R_{A/B} is the distance between position A/B and the fan. In one or more embodiments, the electronic device may store a trained machine learning model that takes user position information and fan speed as inputs and outputs an estimate of the fan noise perceived. For example, the user position information may include one or more of a distance with respect to the electronic device, the angle between the user and the electronic device, and the angle between a first chassis and the second chassis of the electronic device.

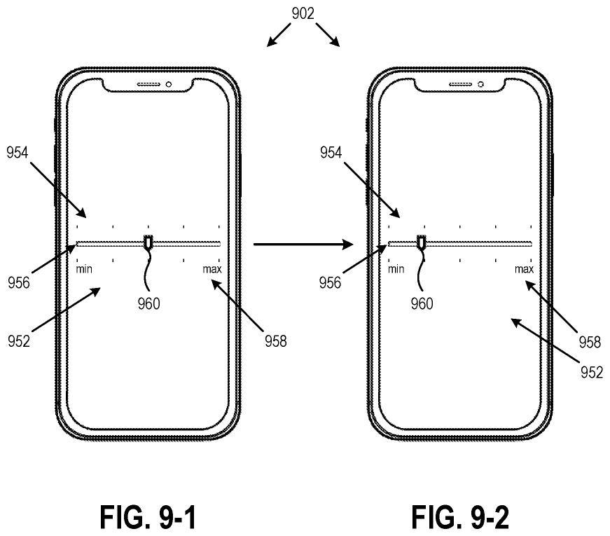

FIGS. 9-1, and 9-2 illustrate stages of an example user interface for changing a noise threshold, in accordance with at least one or more embodiments. In one or more embodiments, a noise threshold 952 is set by the manufacturer. As shown in FIG. 9-1, the electronic device 902 provides a user interface (UI) that shows the fan noise threshold set by the manufacturer. The UI in FIG. 9-1 provides a slider bar 954 for a user to change the fan noise threshold between a minimum (min) 956 and a maximum (max) 958. After the user slides the indicator 960 from the first position shown on FIG. 9-1 to a second position shown on FIG. 9-2, the system may run the fan for a short period of time (e.g., for two seconds) at the new fan noise level perceived at the user's position. This may allow the user test if the new selected fan noise level is acceptable for them or not.

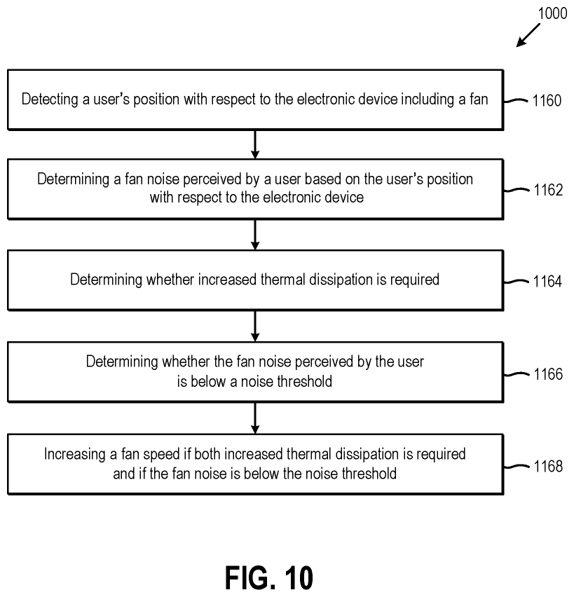

FIG. 10 illustrates a series of acts 1000 for controlling fan noise in an electronic device, in accordance with at least one or more embodiments. While FIG. 10 illustrates acts according to one or more embodiments, alternative embodiments may omit, add to, reorder, and/or modify any of the acts shown in FIG. 10. The acts of FIG. 10 can be performed as part of a method. Alternatively, a system can perform the acts of FIG. 10. In still further embodiments, a device can perform the acts of FIG. 10.

As shown in FIG. 10, the series of acts 1000 may include an act 1060 of detecting a user's position with respect to the electronic device including a fan. In one or more embodiments, detecting the user's position with respect to the electronic device is initiated when the fan starts to rotate. In one or more embodiments, the user's position is detected by a sensor. For example, the sensor may be one or more of a Time-of-Flight (ToF), a Light Detection and Ranging (LiDAR), and a Millimeter-Wave Radar. In one or more embodiments, the user's position is measured by a three-dimensional (3D) algorithm based on one or more images captured by one or more cameras. In one or more embodiments, detecting the user's position is detected at set intervals while the fan is rotating. For example, the detection interval may be between 2-3 minutes. In another example, the detection interval may be between 10-20 minutes.

The series of acts 1000 may further include an act 1062 of determining a noise of the fan perceived by a user based on the user's position with respect to the electronic device. For example, the user's position with respect to the electronic device may be compared to a table that provides information about perceived noise of a fan based on a position information with various different fan speeds.

The series of acts 1000 may further include an act 1064 of determining whether increased thermal dissipation is required. In one or more embodiments, in determining whether the increased thermal dissipation is required includes detecting an increase of heat inside the electronic device. In one or more embodiments, in determining whether the increased thermal dissipation is required includes detecting a requirement to increase performance of a processor.

The series of acts 1000 may further include an act 1066 of determining whether the noise of the fan is below a noise threshold. In one or more embodiments, the noise threshold is set by a manufacturer. For example, the noise threshold may be between 25 dBA and 40 dBA. In one or more embodiments, the noise threshold is set by the user.

In one or more embodiments, in determining that the fan noise is below the noise threshold is based at least one of the user's distance with respect to the electronic device, and the fan speed. For example, when the user's distance is greater than a distance at nominal position, the fan noise is below the noise threshold. In one or more embodiments, the nominal position is set by a manufacturer of the electronic device. In one or more embodiments, the nominal position is set by the electronic device automatically based on usage history. For example, if the electronic device observes that the user is continuously positioned at a certain position in relation to the electronic device, the electronic device may automatically set that observed position as the nominal position.

The series of acts 1000 may further include an act 1068 of increasing a fan speed if both increased thermal dissipation is required and if the noise of the fan is below the noise threshold. In one or more embodiments, the fan speed is increased on a new speed. In one or more embodiments, ambient sound levels surrounding the electronic device are measured. For example, the fan speed may be increased if the ambient sound level is higher than the noise threshold. In one or more embodiments, the noise threshold is based on a maximum allowed fan speed.

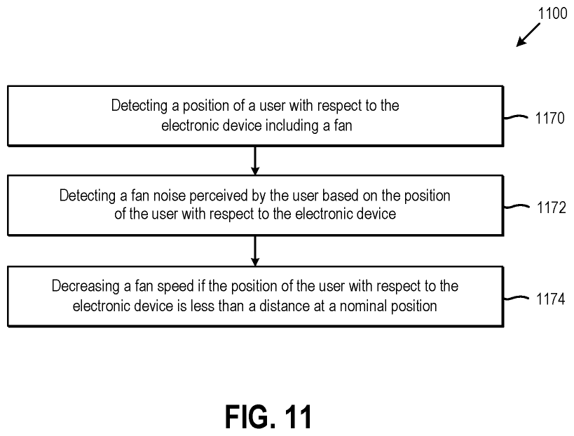

FIG. 11 illustrates a series of acts 1100 for controlling fan noise in an electronic device, in accordance with at least one or more embodiments.

While FIG. 11 illustrates acts according to one or more embodiments, alternative embodiments may omit, add to, reorder, and/or modify any of the acts shown in FIG. 11. The acts of FIG. 11 can be performed as part of a method. Alternatively, a system can perform the acts of FIG. 11. In still further embodiments, a device can perform the acts of FIG. 11.

As shown in FIG. 11, the series of acts 1100 may include an act 1170 of detecting a position of a user with respect to the electronic device including a fan. In one or more embodiments, detecting the user's position with respect to the electronic device is initiated when the fan starts to rotate. In one or more embodiments, the user's position is detected by a sensor. For example, the sensor may be one or more of a Time-of-Flight (ToF), a Light Detection and Ranging (LiDAR), and a Millimeter-Wave Radar. In one or more embodiments, the user's position is measured by a three-dimensional (3D) algorithm based on one or more images captured by one or more cameras. In one or more embodiments, detecting the user's position is detected at set intervals while the fan is rotating. For example, the detection interval may be between 2-3 minutes. In another example, the detection interval may be between 10-20 minutes.

The series of acts 1100 may further include an act 1172 of determining a noise of the fan perceived by the user based on the position of the user with respect to the electronic device. For example, the user's position with respect to the electronic device may be compared to a table that provides information about perceived noise of a fan based on a distance with various different fan speeds.

The series of acts 1100 may further include an act 1174 of decreasing a fan speed if the distance of the user from the electronic device is less than a distance at a nominal position. For example, if the distance of a user is 30 cm, instead of the distance at the nominal position, 50 cm, the fan speed may be decreased to a new speed level so that the noise threshold at 30 cm away is not exceeded.

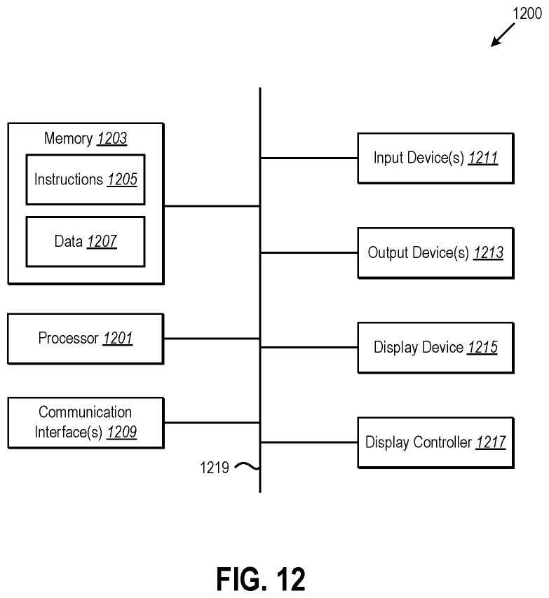

FIG. 12 illustrates certain components that may be included within a computer system 1200, in accordance with one or more embodiments. One or more computer systems 1200 may be used to implement the electrical devices, components, and systems described herein.

The computer system 1200 includes a processor 1201. The processor 1201 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1201 may be referred to as a central processing unit (CPU). Although just a single processor 1201 is shown in the computer system 1200 of FIG. 12, in an alternative configuration, a combination of processors (e.g., an ARM and DSP) could be used. In one or more embodiments, the computer system 1200 further includes one or more graphics processing units (GPUs), which can provide processing services related to both neural network training and graph generation.

The computer system 1200 also includes memory 1203 in electronic communication with the processor 1201. The memory 1203 may be any electronic component capable of storing electronic information. For example, the memory 1203 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1205 and data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during execution of the instructions 1205 by the processor 1201.

A computer system 1200 may also include one or more communication interfaces 1209 for communicating with other electronic devices. The communication interface(s) 1209 may be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 902.11 wireless communication protocol, a Bluetooth® wireless communication adapter, and an infrared (IR) communication port.

A computer system 1200 may also include one or more input devices 1211 and one or more output devices 1213. Some examples of input devices 1211 include a keyboard, mouse, microphone, sensors, cameras, remote control device, button, joystick, trackball, touchpad, and lightpen. Some examples of output devices 1213 include a speaker and a printer. One specific type of output device that is typically included in a computer system 1200 is a display device 1215. Display devices 1215 used with embodiments disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For the sake of clarity, the various buses are illustrated in FIG. 12 as a bus system 1219.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for controlling fan noise in an electronic device, comprising:
detecting a user's position with respect to the electronic device including a fan;
determining a fan noise perceived by a user based on the user's position with respect to the electronic device;
determining whether increased thermal dissipation is required;
determining whether the fan noise perceived by the user is below a noise threshold; and
increasing a fan speed if both increased thermal dissipation is required and if the fan noise is below the noise threshold.

2. The method of claim 1, wherein detecting the user's position with respect to the electronic device is initiated when the fan starts to rotate.

3. The method of claim 1, wherein the user's position is detected by a sensor.

4. The method of claim 3, wherein the sensor includes one or more of a Time-of-Flight (ToF) sensor, a Light Detection and Ranging (LiDAR) sensor, and a Millimeter-Wave Radar sensor.

5. The method of claim 1, wherein the user's position is measured by a three-dimensional (3D) algorithm based on one or more images captured by one or more cameras.

6. The method of claim 1, wherein the fan speed is increased to a new speed.

7. The method of claim 1, wherein the noise threshold is set by a manufacturer.

8. The method of claim 1, wherein the noise threshold is between 25 dBA and 40 dBA.

9. The method of claim 1, wherein the noise threshold is set by the user.

10. The method of claim 1, wherein determining whether the increased thermal dissipation is required includes detecting a requirement to increase performance of a processor.

11. The method of claim 1, wherein determining whether the increased thermal dissipation is required includes detecting an increase of heat inside the electronic device.

12. The method of claim 1, wherein determining that the fan noise is below the noise threshold is based at least one of the user's position in relation to the electronic device, and the fan speed.

13. The method of claim 1, wherein the user's position is greater than a distance at a nominal position.

14. The method of claim 13, wherein the nominal position is set by a manufacturer of the electronic device.

15. The method of claim 1, wherein detecting the user's position is detected at set intervals while the fan is rotating.

16. The method of claim 1, further including measuring ambient sound level surrounding the electronic device.

17. The method of claim 16, further including increasing the fan speed if the ambient sound level is higher than the noise threshold.

18. A method for controlling fan noise in an electronic device, comprising:
detecting a position of a user with respect to the electronic device including a fan;
detecting a fan noise perceived by the user based on the position of the user with respect to the electronic device; and
decreasing a fan speed, if the position of the user with respect to the electronic device is less than a distance at a nominal position.

19. An electronic device for controlling fan noise, comprising:
a fan;
a position detection system; and
means for controlling a fan speed when both the position detection system indicates that a user is further from the electronic device than a distance at a nominal position and that an increase in thermal dissipation is required.

20. The electronic device of claim 19, further including a first chassis and a second chassis connected to each other, and an angle position detector detecting an angle between the first chassis and the second chassis.
